(19) United States
(12) Patent Application Publication
(10) Pub. No.: US 2014/0262986 A1
(43) Pub. Date: Sep. 18, 2014

(54) Facility for Treating Thermal Oils in Solar Thermal Plants

(71) Applicant: Jesús Lacalle Bayo, Valencia (ES)

(72) Inventor: Jesús Lacalle Bayo, Valencia (ES)

(73) Assignee: GD ENERGY SERVICES S.A.U., Valencia (ES)

(21) Appl. No.: 14/351,216

(22) PCT Filed: Oct. 14, 2011
(86) PCT No.: PCT/ES2011/070712

§ 371 Date: Apr. 11, 2014

(51) Int. Cl. B01D 36/04; B01D 21/02

(52) U.S. Cl. CPC B01D 36/04; B01D 21/02
USPC 210/87

(57) ABSTRACT

An installation for processing thermal oils at thermal solar plants, includes an intake for connecting to an outlet circuit of the solar thermal plant; an oil-cooling device; a first decanting tank (4); a second decanting tank (7); a third tank (8), which serves as a flow-control tank, receiving oil that has been treated before the oil is fed back into the plant; a filtering unit (12) placed downstream of the second tank (7) and upstream of the third tank (8); a set of control valves; and a set of inspection pressure gauges, thermometers and flowmeters placed at various points of the facility.

This invention refers to an installation for processing thermal oils at thermal solar plants, in which the oil can be continuously processed with no need for the plant to halt its operations.

Solar thermal plants comprise conduits which take in the radiation from solar collectors and which are normally connected to main conduits in which the oil is taken to a heat exchanger from a vapour installation, for example; after losing its heat in the exchanger this is reincorporated in the thermal collection circuit or taken to a storage tank.

The nature of the thermal oils used in these installations means that these are extremely corrosive and in spite of the materials used being anti-corrosive, in actual fact this causes the deterioration of some of the elements, which has mainly two effects:
A first effect is the contamination of the oil, either by solid particles from the components of the installation or through other fluid components, such as water from the vapour installation);
The oil contaminated with solid particles increases the degree of erosion in the oil circulation circuit, and this could be critical in components such as the discharge pumps or heat exchangers, in which the entire flow is split into small conduits;
Oil contaminated with water has different consequences:
   One of these is that boiling is caused at a relatively low temperature when heated by the solar collectors; given that the volume taken up by the vapour is not occupied by thermal oil, and that the specific heat of the thermal oil is much greater than that of water vapour, there is a significant drop in energy yield;
   Another consequence is that the pressure inside the conduits increases considerably, an unwanted effect which means that there is a greater risk of breakages in the installation, or that this needs to be dimensioned to withstand these high pressures, with the resulting excess cost.

### STATE OF THE ART

At present, when the thermal oil in a thermal solar installation is found to be contaminated, the installation has to be stopped and all the oil withdrawn, to be sent to the manufacturer for regeneration or managed as waste. In either of these two cases the costs arising are very high.

Apart from the ordinary maintenance costs for the installation, this means a problem through entailing the stoppage of the plant, which generates significant economic losses through not producing energy. The processing of the oil furthermore takes place in plants located at some distance from the thermal solar plant, meaning that the contaminated or refill oil has to be transported in tanks, also increasing the transport costs.

At the high temperatures which this reaches, this oil means a high risk of fire, for which reason the transfer has to be carried out with all kinds of precautions and using special safety transport.

The author is unaware of any other specific solutions for on-site processing of the oil from the thermal solar plant.

### DESCRIPTION OF THE INVENTION

This invention describes an installation for processing thermal oils at thermal solar plants, which comprises:
A connection socket with an outlet circuit from the thermal solar plant;
An oil-cooling device (air cooler). This cooling device comprises a plurality of cooling elements arranged in series and/or in parallel, each of the said cooling elements comprising a heat exchanger and a blast ventilation device;
A first settling tank;
A second tank in which a second settling operation is performed;
A third tank, which acts as a flow regulator tank, receiving oil that has previously been processed prior to its reincorporation in the plant; according to the embodiment proposed the third tank will normally be placed back-on to the second tank, and the oil already processed and filtered is received in this third tank, prior to its reinsertion in the thermal solar tank or loading on a tanker truck;
A filtration assembly provided with different lines set in parallel, each of these formed of at least one stage, and preferably with more than one of these being provided with decreasing pitch cartridge filters;
Outlets of oily waters coming from the settling operation in the tanks;
Oil discharge pumps;
At least one return line to the oil tanks of the thermal solar plant;
At least one outlet line for taking samples;
At least one outlet line for loading a tanker truck;
At least one oil inlet line for tankers or some other source for processing;
A set of control valves, and
A set of manometers, thermometers and control flow meters placed at different points in the installation.

### DESCRIPTION OF THE DRAWINGS

In order to illustrate the following explanation, we are enclosing a sheet of drawings with this descriptive report, in which a single sheet represents the essence of this invention, and in which it shows a diagram of the installation for processing thermal oils at thermal solar plants according to the invention.

### DESCRIPTION OF THE PREFERENTIAL EMBODIMENT

As has been stated, the invention describes an installation whose purpose is to carry out processing and purification of the thermal oil at a thermal solar plant.

The oil from the plant is at a fairly high temperature, which makes it difficult to process. Hence the installation being proposed comprises an inlet manifold (1) connected to the circuits or the oil tanks of the thermal solar plant. Due to the high pressures at which the oil is kept in the thermal solar plant, up to 20 bar, there are pressure reducers in this manifold, for lowering this to 2-6 bar, so that the safety conditions in the different items are the ones matching these pressures and not the pressure at the connection to the plant.

The following stage of the installation is made up of an air cooler (2). The air cooler (2) consists of a set of several cooling units (28) which comprise a heat exchanger and a fan. The inlet temperature to the installation of the invention can be between the maximum operating temperature, around 400° C., and the operating temperature of some systems, around 250° C. The processing temperature is about 50-80° C. Hence, the number of cooling units (28) that will be running will be determined depending on the inlet-outlet temperatures, as well as the ambient temperature. There is also a possibility of the fans having a variable speed, which will in turn modify the air flow and the cooling capacity. The cooling units could be connected in series, in parallel or in a combined system, with at least two lines in parallel provided with more than one unit in series.

After verifying that the temperature is ideal for the treatment, the corresponding shut-off valves will be open, with the thermal oil being taken through the conduit (3) to a first tank (4). The first tank (4) is at atmospheric pressure.

An outlet (24) for taking samples is designed prior to processing, and an outlet (25) for external discharge, such as to a tanker truck.

The aforementioned first tank (4) has a set of inlet connections and a set of outlet connections. The first of the inlets comes from the conduit (3), which in turn comes from the air cooler (2). There is another inlet (19) which can come from different sources, such as for example:
A return line from a second tank (7); the return line may be used for example, through detecting excess water in the resulting oil, or for flow regulation;
A connection with a line (18) for discharging from an external source, such as a tanker truck.

The main discharge of the first tank (4) takes place by means of a line (21), which comprises a discharge pump (6), and which leads this to the second tank (7). In spite of this other outlets (20,22) are designed for maintenance drainage and as outlets for external collection of the settled floating oily waters, for example by means of a tanker truck.

Through a conduit (5), the discharge pump (6) leads the oil that has already been subjected to a first settling process and from which a certain amount of oily water has been extracted, to the second tank (7).

The entry of oil to the first tank (4) is allowed by means of a conduit leading to a zone protected, for example, by means of a grille or perforated plate wall, which prevents the formation of turbulence inside this tank.

The tanks are also preferably divided into sections by means of walls that are also made of grilles or perforated plates.

Since the oils used for these purposes are heavier than water, the water floats on the oil, meaning that the collection has to be performed from the top. For this reason floats are designed with absorption intakes which collect the liquid found at the surface. The oil outlet thus takes place from the bottom of the tank, meaning that the water separation is extremely efficient. The first settling tank (4) and the second settling tank (7) furthermore comprise a visor (a transparent window), through which the level of oil and water can be seen, which allows running or stopping the extraction system, or opening or closing the relevant valves. The process can nevertheless be automated by means of the corresponding detectors on the different levels.

The oil from the first tank (4) goes, as already stated, to the second tank (7), in which a second settling process is performed, and in which the oil is again extracted at the bottom and the water at the top through an oily water outlet (23). The characteristics of the second tank (7) are essentially the same as those of the first tank (4).

The second tank comprises an outlet conduit (9) provided with a pump (10), which takes the oil to an inlet line (11) to a filtration assembly (12). The filtration assembly (12) comprises one or more sets of filters (13) with a decreasing mesh size arranged in series. The sets of filters are placed in parallel with each other, and the number of sets will depend on the flow required. Each filter (13) is isolated by means of valves and comprises at least one manometer which enables learning its condition for replacing this if necessary.

The oil from the filtration assembly (12) is taken by means of a line (14) to a third tank (8), from which this is led on to an outlet line (15). The outlet line (15) comprises a pump (29) which should provide at least the rated pressure of the installation to which the oil is reincorporated. This pump takes the oil to a line (16) for connection to an inlet manifold (17) and for return to the thermal solar plant.

By opening and closing the proper valves, the outlet line (15) takes the oil by means of the pump (29), either to an outlet for taking samples (26) or to an outer discharge outlet (27), for example for a tanker truck.

The installation comprises a set of control valves and a set of manometers, thermometers and control flow meters placed at different points in the installation.

The installation is dimensioned in such a way that this is arranged in three standard 20-foot containers: A first container houses the air cooler and possible the filtration assembly; a second container will house the first tank, and a third container will house the second and third tanks. The pumping systems may be placed in the first container or be located in the different containers, as may prove most convenient. During transport the inside of the containers is used to house the different conduits for connection between the items. This comprises retention trays for fitting the different items.

What is claimed is:

1. An installation for processing thermal oils at thermal solar plants, comprising:
at least one connection with an outlet circuit from a thermal solar plant;
at least one oil-cooling device connected with the at least one connection;
a first settling tank which takes in oil from the cooling device;
a second settling tank in which a second settling operation is performed, and connected with an output of the first settling tank;
a third tank, which acts as a flow regulating tank, and which receives oil already processed prior to its reincorporation in the plant;
a filtration assembly arranged after the second tank and before the third tank;
a set of control valves placed at different points in the installation; and
a set of manometers, thermometers and control flow meters placed at different points in the installation.

2. An installation, according to claim 1, wherein the oil-cooling device includes an air cooler having a set of cooling units arranged at least one of in series and in parallel.

3. An installation, according to claim 1, wherein the cooling units include a fan and a heat exchanger towards which the fan sends air.

4. An installation, according to claim 1, wherein at least one of the first tank and the second tank comprise at least one zone protected of at least one of a grille and perforated plate wall into which the oil to be processed is sent.

5. An installation, according to claim 1, wherein at least one of the first tank and the second tank are split into sections walls made of at least one of grilles and perforated plates.

6. An installation, according to claim 1, wherein at least one of the first tank and the second tank comprise at least one float fitted with absorption intakes, which collect oily water found on the surface as well as absorption outlets for oil in a lower zone.

7. An installation, according to claim 1 wherein at least one of the first tank and the second tank comprise at least one of a visor and transparent window through which an oil and water level can be observed.

8. An installation, according to claim 1, wherein the second tank and the third tank are joined with each other.

9. An installation, according to claim 1, wherein the filtration assembly includes at least two lines arranged in parallel, each of these being formed of at least one stage provided with decreasing pitch cartridge filters.

10. An installation, according to claim 1, further comprising a pump fitted after each of the first, second and third tanks.

11. An installation, according to claim 1, further comprising a return line from the second tank to the first tank.

12. An installation, according to claim 1, further comprising outlets for taking samples and for loading tanker trucks.

13. An installation, according to claim 1, further comprising at least one intake for oil from an external supply of a tanker truck.

14. An installation, according to claim 2, further comprising three 20-foot containers, which includes:
a first container which houses at least one of the air cooler and the filtration assembly;
a second container which houses the first tank; and
a third container which houses the second and third tanks;
using the tanks as a housing for conduits connecting elements of the installation.
